(19) United States
(12) Patent Application Publication
(10) Pub. No.: US 2007/0000550 A1
(43) Pub. Date: Jan. 4, 2007

(54) Flexible multiple tubing that resists collapsing and kinking

(76) Inventor: Tomas Kazimierz Osinski, Los Angeles, CA (US)

Correspondence Address: TOMAS K. OSINSKI, 4240 GLENMUIR AVE, LOS ANGELES, CA, 90065, US

(21) Appl. No.: 11/151,799

(22) Filed: Jun. 14, 2005

(51) Int. Cl. F16L 11/00

(52) U.S. Cl. 138/118; 604/43; 138/111

(57) ABSTRACT

A flexible larger outer tube (1) with inserted smaller flexible multiple inner tubes (3) for transfer of liquids or gasses.

The assembly of smaller tubs located in larger tube allow for the liquid or gasses to be transfer inside the smaller inner tubes (3) and in spaces between the inner tubes and large outer tube (4) under pressure or suction. The combination of flexible outer tube and smaller flexible inner tubes prevents the assembly from collapsing or kinking.

### CROSS-REFERENCE TO RELATED APPLICATIONS

(Not Applicable)

### BACKGROUND

1. Field of Invention

This invention relates to flexible tubing used for transfer of liquids or gases.

2. Prior Art

Flexible tubing is commonly used for the transfer of liquids or gases. The problem with the presently used flexible tubing is the tendency for it to collapse or kink.

A tube collapsing or kinking restricts the flow of liquids or gases inside the tube. The existing solutions to this problem include various way of reinforcing single tubes using other materials, then the tube itself or by increasing the thickness of the wall of the tube or implementing corrugation of the wall of the tube. Kinking occurs in the moment when the exterior forces, mainly bending, cause the tube to bend beyond the point of the structural resistance of the material used to flex.

At this point the tube collapses closing all or the most of the inside opening, stopping or restricting the flow of transferred liquids or gases.

One of the remedies of this problem is to reinforce the tube itself which results in a tube that is less flexible. Very often stronger tube resists kinking longer but when exterior forces are strong enough the tube kinks and the tube material can be permanently weakened at the place of kinking.

Basically less reinforced tubes kink more but they are more flexible. The more reinforced tubes kink less but they are less flexible.

Any material subjected to external force has a point of failure. When the failure occurs material changes its structural properties (weakens) and in the case of plastic tube the failure will occur repeatedly in the same place.

### BRIEF SUMMARY OF THE INVENTION

The general idea of this invention is to combine larger outer tubing with smaller multiple inner tubing placed inside the outer tubing. By doing so this combination tubing will resist collapsing or kinking.

Said tubing will resist collapsing or kinking under pressure or suction retaining its flexibility.

### DRAWING FIGURES

FIG. 1: Shows an isometric view of a tube

FIG. 2: Shows a section of the tube

FIG. 3: Shows a section of the tube with the outside force applied.

FIG. 4: Shows a section of the tube bent.

### REFERENCE NUMERAL IN DRAWINGS

10 Larger outer tube
20 Smaller inner tubes
30 Inside tube flow area
40 Flow area in between tubes

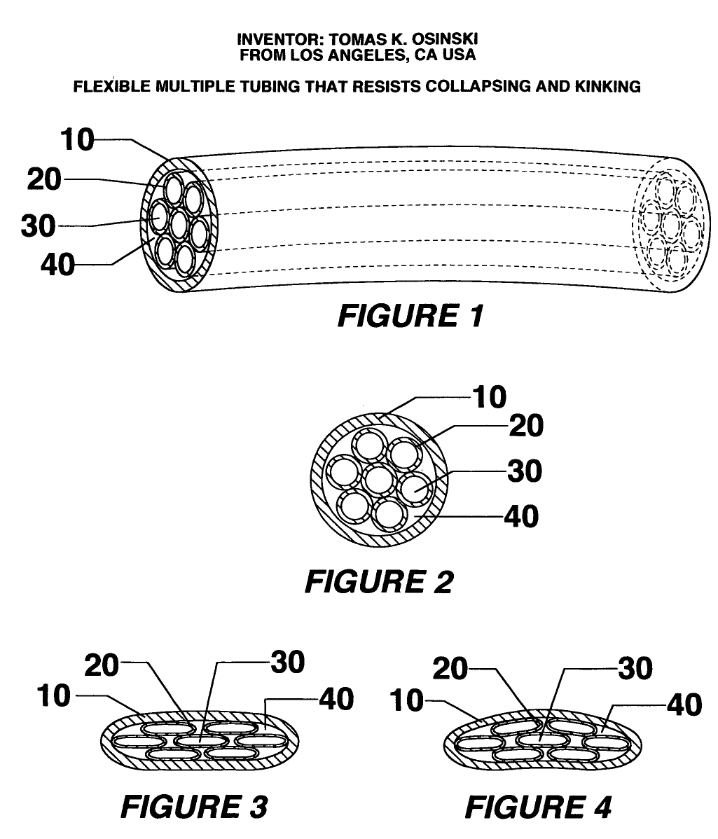

### DESCRIPTION—FIGS. 1 TO 4

The flexible inner tubes 20 located inside a flexible larger outer tube 10 allow the liquids or gases to be transported inside smaller tubes 30 and through spaces between inner tubes and the inside of the wall of the outer tube 40.

A placement of smaller inner tubes 20 inside a larger outer tube 10 (FIG. 2) causes a multi-tube assembly (FIG. 1) to resist total collapsing under exterior pressure applied to the tube (FIG. 4) or from excessive bending or kinking of the tube (FIG. 3).

### INVENTION DESCRIPTION

This invention applies the idea of combining a flexible larger outer tube with smaller multiple inner tubes.

The other tube and inner tubes have a dissimilar point of failure while subjected to exterior forces.

The bigger other tube can bend to certain radius and if bent more it would structurally fail and kink.

The inner tubing having a much smaller diameter can withstand much radical bending before structural failure.

The inner tubing by being located inside outer tube prevents the assembly of the tubes from extreme bending and collapsing.

At the same time the tube assembly is staying open and allowing the flow to continue inside the small tubing and in between the small tubing and interior wall of outer tube.

When a tube is bent or a force is applied from the outside on a tube, the smaller inner tubes being located in physically constrained space resist bending and collapsing and by doing so, keep the flow area partially open.

A similar mechanism prevents the tube assembly from collapsing when the suction is applied to the inside of a tube.

### OBJECTS AND ADVANTAGES

A. To provide flexible tubing resisting collapsing and kinking for the transport of liquids or gases under pressure.

B. To provide flexible tubing resisting collapsing and kinking for the transport of liquids or gasses under suction.

Exterior force applied to a single flexible tube of the same diameter and of the same wall thickness causes its total collapse and prevents liquids or gases from flowing through. If the same exterior force is applied to a multiple tubing assembly as shown (see FIGS. 3 and 4), causes only a partial collapsing (FIG. 4) or kinking (FIG. 3) of the tube allowing liquids or gases to travel through.

Although the description and drawings attached contains many specificities, these should not be constructed as limiting the scope of the invention.

For example the number of inner tubes may vary, the shape of the inner or outer tube may be other than circular, it can be triangular, rectangular or elliptical, the inner tubes may be twisted or straight, the length and diameter of the tub system may vary, etc.

What I claim as my invention is:

1. A flexible tubing assembly for transportation of liquids and gases under pressure or suction comprising:
a. an flexible outer tube and
b. a number of flexible inner tubes placed inside of said flexible outer tube and
c. where said inner tubes support structurally said outer tube and
d. a combination of said outer tube and said inner tubes prevents the tubing assembly from collapsing and kinking.
